(19) United States
(12) Patent Application Publication
(10) Pub. No.: US 2012/0109496 A1
(43) Pub. Date: May 3, 2012

(54) FUEL INJECTION SYSTEM

(75) Inventors: Darryl W. Hylands, Nottingham (GB); Trevor L. Fletcher, Leicestershire (GB)

(73) Assignee: T BADEN HARDSTAFF LIMITED, NOTTINGHAM (GB)

(21) Appl. No.: 13/148,084

(22) PCT Filed: Feb. 5, 2010
(86) PCT No.: PCT/GB10/00218

§ 371 Date: Oct. 20, 2011

(30) Foreign Application Priority Data
Feb. 5, 2009 (GB) 0901903.5

(51) Int. Cl. F02D 41/30

(52) U.S. Cl. 701/103

(57) ABSTRACT

A method for controlling the supply of a first fuel and a second fuel to an engine, which engine is fuelled by the first fuel only in a first mode of operation and by a mixture of the first fuel and the second fuel in a second mode of operation, the method comprising the steps of: 1) calculating the mass of first fuel Md required by the engine if running in the first mode; 2) calculating from the mass Md, the fuel energy Fe that the amount of mass Md would provide; 3) determining a minimum reduced amount of diesel fuel Fdmin with which it is desired to operate in the second mode; 4) calculating the amount of second fuel Msub, which together with the reduced amount of diesel fuel Fdmin will provide a fuel energy equivalent to Fe.

The present invention relates to a fuel injection system for a multi fuel engine.

It is known to power an engine using more than one fuel; for example it is known to run, in a first mode of operation, a diesel engine on diesel fuel only or, in a second mode of operation a combination of diesel fuel and another fuel such as natural gas or LPG (liquid petroleum gas), such as propane.

An example of such a multi fuel engine is described in our PCT patent application number PCT/GB2008/003188.

When a multi fuel engine is being run on a combination of fuels, it is a requirement to supply the correct amounts of fuel to the relevant cylinders of the engine in order to ensure that the engine runs smoothly and efficiently.

It is a general objective of the present invention to provide a fuel injection system for a multi fuel engine which aims to meet the above requirement.

According to an aspect of the present invention there is provided a method for controlling the supply of a first fuel and a second fuel to an engine, which engine is fuelled by the first fuel only in a first mode of operation and by a mixture of the first fuel and the second fuel in a second mode of operation, the method comprising the steps of:
1) calculating the mass of first fuel Md required by the engine if running in the first mode;
2) calculating from the mass Md, the fuel energy Fe that the amount of mass Md would provide;
3) determining a minimum reduced amount of diesel fuel Fdmin with which it is desired to operate in the second mode;
4) calculating the amount of second fuel Msub, which together with the reduced amount of diesel fuel Fdmin will provide a fuel energy equivalent to Fe.

By means of the present invention is possible to substitute an appropriate amount of the second fuel Msub during the second mode of operation of the engine, to compensate for the reduced amount Md of the first fuel without having to carry out any mapping of the engine system.

In an embodiment of the invention, the step of determining Fdmin comprises the step of looking up data stored in a memory which correlates different Fdmin to different Fe values, which correlation has been predetermined by experiment on the basis of the minimum amount of first fuel required to maintain safe operation of the engine using different amount of mixtures of first and second fuel under predefined conditions.

Because Fdmin can be calculated using data already stored in a memory, it is not necessary to carry out any mapping of the engine system. Such a mapping process can be very time consuming.

The method may comprise a further step at step 3) of determining whether operation in the second mode is feasible.

In this regard, the minimum fuel energy value required, Fe, for operating in the second mode to be possible is predetermined by experimentation and stored within a memory.

The calculated fuel energy value Fe is then compared with the minimum value, and the engine is allowed to run in the second mode if the calculated fuel energy value Fe is greater than or equal to the minimum value.

In an embodiment of the invention, the method comprises the further step at step 3) of enforcing a pre-set minimum substitute limit, or an upper limit to the amount of reduced first fuel Fdmin.

Such a limit is desirable because the benefits of, for example substituting only a very small amount of first fuel with the second fuel would be minimal.

In an embodiment of the invention, the step of calculating the amount of second fuel Msub comprises the further steps of:
calculating the air to fuel ratio AFRd required to operate the engine in the first mode based on the use of the mass of first fuel Md;
determining the air to fuel ratio AFRdual required when operating the engine in the second mode in order to provide the same performance as when using the first fuel mass Md at AFRd;
calculating the amount of second fuel Msub required to provide, in combination with the fuel energy Fdmin the AFRdual.

In embodiments of the invention, the method further comprises the further step of: conducting a comparative check to ascertain whether the energy Fe is substantially the same as the energy provided by the calculated required amounts of first and second fuel.

According to a second aspect of the invention there is provided a fuel injection system for an engine having a first electronic control unit arranged to control a plurality of main injectors for delivering a first fuel to the cylinders of the engine such that in a first mode of operation, the engine is fuelled by the first fuel only under the control of said first electronic control unit, the fuel injection system being arranged to operate to fuel the engine in a second mode of operation wherein a mixture of the first fuel and a second fuel is used to fuel the engine, the fuel injection system including a plurality of subsidiary injectors for delivering the second fuel into the engine, a second electronic control unit for controlling operation of the subsidiary injectors, the second electronic control unit being operatively connected to the first electronic control unit to receive output injector control signals therefrom and being connectable to the said main injectors for operating, in said second mode of operation, the main injectors to supply a reduced amount Fdmin of the first fuel and to control the subsidiary injectors to supply an amount of the second fuel Msub to provide a predetermined combined air to fuel ratio AFRdual for each power stroke of the engine.

According to a third aspect of the present invention there is provided a fuel injection system for an engine, the system including a first electronic control unit arranged to control a plurality of main injectors for delivering a first fuel to the cylinders of the engine such that in a first mode of operation, the engine is fuelled by the first fuel only under the control of said first electronic control unit, a second electronic control unit operable to fuel the engine in a second mode of operation wherein a mixture of the first fuel and a second fuel is used to fuel the engine, the system further including a plurality of subsidiary injectors for delivering the second fuel into the engine, the second electronic control unit being operably connected to the first electronic control unit to receive output injector control signals therefrom and in response to said output injector control signals, being arranged to control operation of the main and subsidiary injectors to supply a reduced amount Fdmin of the first fuel and to control the subsidiary injectors to supply an amount of the second fuel Msub to provide a predetermined combined air to fuel ratio AFRdual for each power stroke of the engine.

The fuel injection system according to either the second aspect or the third aspect of the invention may be configured such that control signals pass through the second ECU when the engine is running in the first mode, and also when it is running in the second mode.

Various aspects of the present invention are hereinafter described with reference to the accompanying drawings, in which:

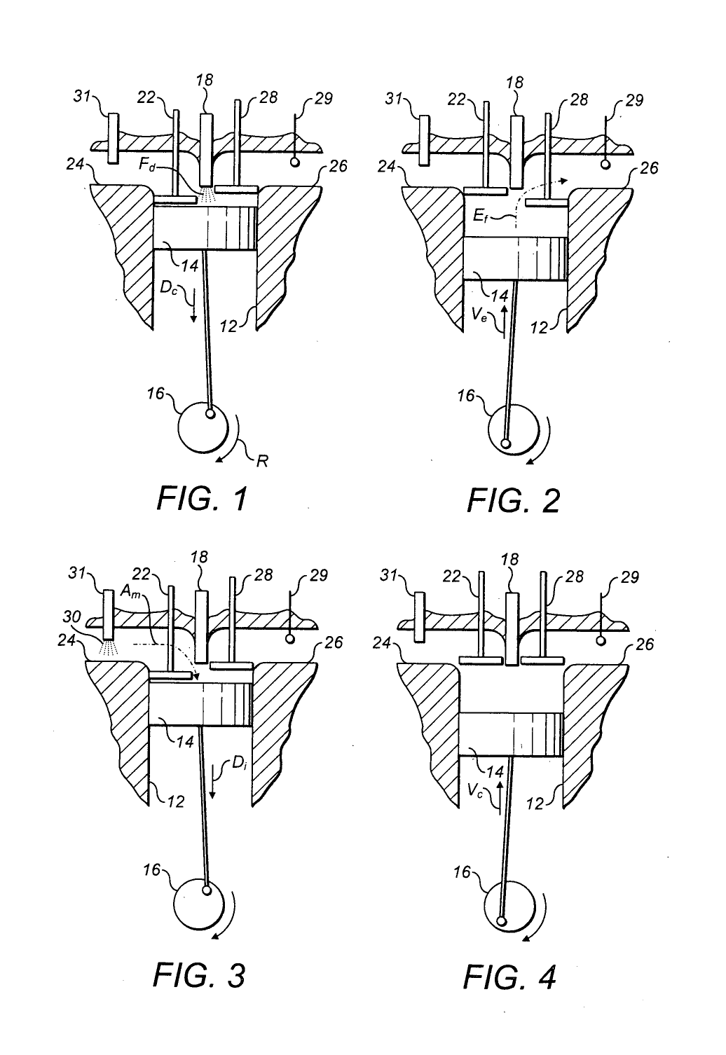

FIGS. 1 to 4 diagrammatically illustrate various stages of operation of a 4 stroke diesel engine operating in accordance with a preferred embodiment of the invention;

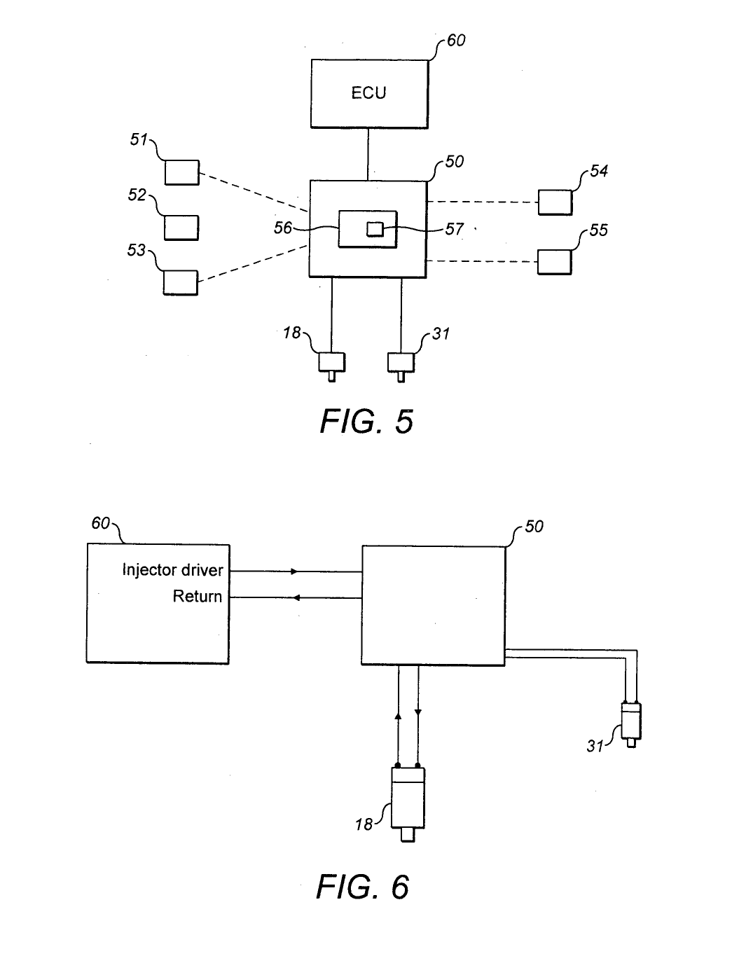

FIG. 5 is a block diagram illustrating a system according to an embodiment of the present invention;

FIG. 6 is a block diagram illustrating how, the first and second ECUs may be connected to one another; and

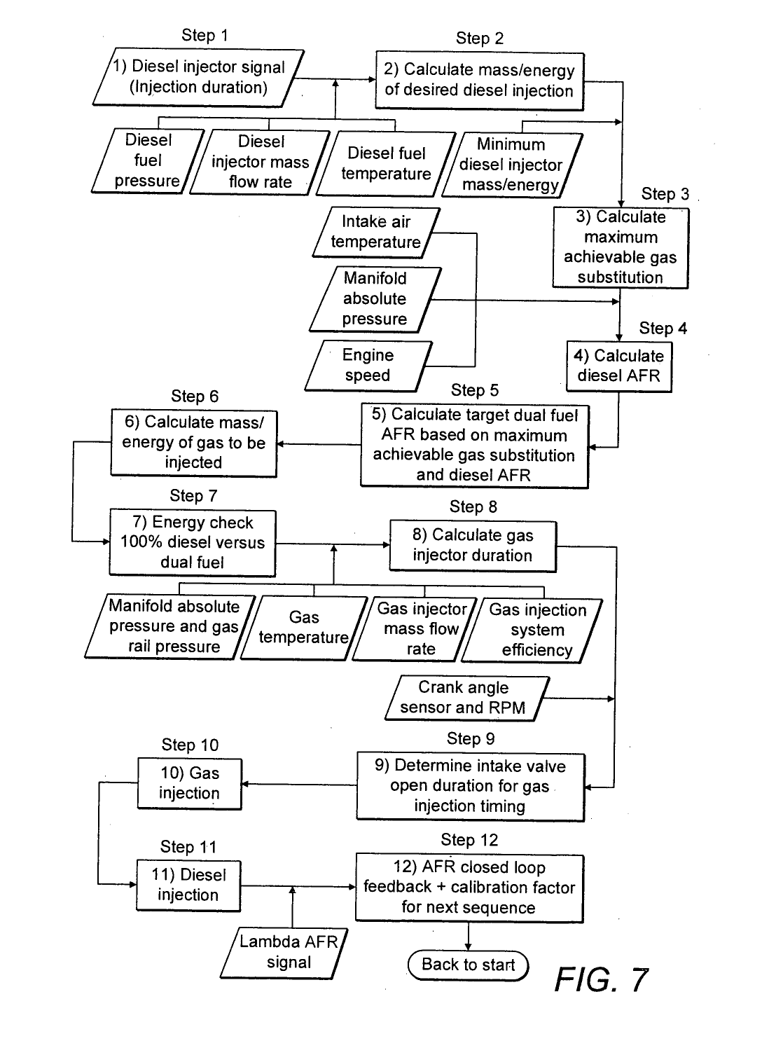

FIG. 7 is a flow diagram illustrating stages in the operation of the system according to an embodiment of the present invention.

Referring initially to FIG. 1 there is shown a cylinder 12 of a diesel engine. A piston 14 located in the cylinder 12 is shown connected to a crankshaft 16 which rotates in the direction of arrow R.

An air intake duct 24 is provided for supplying air into the cylinder 12 via an inlet valve 22 and an exhaust gas duct 26 is provided for conveying combustion gases out of cylinder 12 via an outlet valve 28.

In FIG. 1, both the valves 22, 28 are closed, the piston 12 has just passed top dead centre and a diesel fuel injector 18 has just injected diesel fuel Fd; as a consequence combustion has been initiated to power the piston in the direction of arrow Dc. This is the power stroke of the engine.

As shown in FIG. 2, after passing bottom dead centre, the piston 14 rises in the direction of arrow Ue; outlet valve 28 is opened with valve 22 remaining closed and so combustion gases are exhausted through the exhaust duct 26 (the flow of exhaust gases out of the cylinder 12 is represented by arrow Ef in FIG. 2). This is the exhaust stroke of the engine.

In FIG. 3, the piston 14 has just passed top dead centre and descends in the direction of arrow Di. The inlet valve 22 is opened and outlet valve 28 is closed. Accordingly air is drawn into the cylinder 12 as the piston descends (the flow of air into the cylinder 12 is represented by arrow Am in FIG. 3). This is the induction stroke of the engine.

During the induction stroke, in accordance with the present invention a predetermined amount of a second fuel 30 is introduced by a second fuel injector 31 into the air flow being drawn into the cylinder 12.

In FIG. 4, the piston 14 has just passed bottom dead centre and is rising in the direction of arrow Uc. Both inlet valve 22 and outlet valve 28 are closed and so the air and second fuel mixture contained in the cylinder 12 is compressed as the piston continues to rise in the direction of arrow Uc. This is the compression stroke of the engine.

When the piston just passes top dead centre, diesel fuel injector 18 injects a predetermined amount of diesel fuel Fd which combusts and ignites the air and second fuel mixture. This is represented in FIG. 1 and completes the cycle of the engine.

With a diesel engine running on diesel fuel only, injector 18 will inject the correct amount of diesel fuel through injector 18 after completion of the compression stroke of the engine. This amount of diesel fuel is determined by a first electronic control unit (ECU) 60 supplied by the original equipment manufacturer (OEM) which, in a known way, is programmed to monitor the performance of the engine and, if the engine is installed in a vehicle, other performance characteristics of the vehicle.

The OEM ECU in response to monitored conditions of the engine and vehicle, controls the supply of fuel in order to ensure that the engine runs in a predetermined manner under predetermined load/running conditions. This control is usually manifested by the OEM ECU 60 outputting an injector control signal to a diesel fuel injector 18 to open the injector 18 for a predetermined length of time and altering the duration of time for which the injector 18 dispenses fuel and/or the timing of opening of the injector 18 to begin injection of fuel.

In accordance with an aspect of the present invention, there is shown in FIG. 5 a second electronic control unit 50, comprising a multi fuel ECU which, in response to control signals issued by the OEM ECU 60, controls the supply of diesel fuel to the diesel fuel injector 18 and also controls the supply of a second fuel to the second fuel injector 31 to achieve the desired air to fuel ratio (AFR) in the cylinder during the compression stroke as well as delivering the desired amount of diesel for initiation of the power stroke.

In some embodiments of the invention the first ECU 60 and the second ECU 50 are connected together in such configuration that control signals pass through the second ECU 50 regardless of which mode of operation the engine is in. It is thus not necessary to switch the second ECU 50 into and out of operation. One such configuration is illustrated schematically in FIG. 6.

As will be described in more detail below, the multi fuel ECU 50 is connected to various inputs and sensors (illustrated in FIG. 5 by boxes 51 to 55) which provide signals to the ECU 50 that are indicative of variable performance characteristics that affect the determination of the correct amount of diesel and second fuel which needs to be injected at a given time to provide desired operation of the engine.

In FIG. 5 box 51 represents inputs relating to the operating conditions of the diesel fuel (these inputs include RPM (engine speed) and diesel injector pulse width (which is provided by the OEM ECU 60)).

Box 52 represents sensors required to determine the operating conditions of air in the air intake manifold 24 (these sensors include temperature and pressure sensors which monitor the temperature and pressure of the air in the intake manifold 24, and also include an engine speed sensor). In other embodiments of the invention (not shown) the engine speed sensor may be separate from the air temperature and pressure sensors.

Box 53 represents sensors required to determine the operating conditions of the second fuel 30. In the present example, the second fuel is natural gas which is supplied to the injector 31 in the form of a gas. Accordingly the sensors represented by box 53 include sensors which determine the fuel gas temperature and pressure being supplied to the injector 31.

Box 54 represents sensors required to provide signals representative of the engine performance such as engine speed (in the form of revolutions per minute (RPM)) and angle of crank 16.

Box 55 is representative of sensors provided in the exhaust duct 26 which supply feedback signals representing desired performance characteristics, such as efficiency of combustion. For example, such a sensor could be a lambda sensor 29 (FIGS. 1 to 4) which senses the amount of unused oxygen in the exhaust gases flowing along duct 26.

In addition the ECU 50 includes a microprocessor 56 for performing the determination of the required amounts of diesel and secondary fuel; in order to enable the microprocessor to make such determinations it also includes a memory 57 in which is stored predetermined reference performance data. Such data includes, for example, metering characteristics of the injectors 16 and 31, calorific values of diesel and second fuel, and a table of predetermined air to fuel ratios for different amount combinations of the mixed fuels.

FIG. 7 illustrates a logic flow diagram for a multi fuel ECU 50 according to a preferred embodiment of the present invention; the calculations referred to in the flow diagram are performed by the microprocessor 56.

In the diagram of FIG. 6, the start of a control sequence starts at Step 1 with the second ECU 50 receiving a control signal from the OEM (first) ECU 60 to initiate a power stroke. This control signal indicates to the microprocessor 56 the duration of activation of the injector 18 required by the OEM ECU 60 to deliver diesel fuel only to the cylinder 12 for correct operation of the engine.

At the next step, Step 2, the microprocessor 56 calculates the mass Md of the diesel fuel intended to be injected under the control of ECU 60 for the combustion stroke and from the calculated mass Md calculates the fuel energy Fe (i.e. the calorific content) the amount of mass Md of diesel fuel would provide.

In determining the mass Md, the microprocessor receives input signals, via box 51, relating to the diesel injector signal pulse width and the RPM. Other criteria needed to make the calculation are stored in memory 57, e.g. predetermined calibrated mass flow rate for the diesel injector 16.

At the next step, Step 3 the microprocessor 56 uses the calculated fuel energy value Fe to determine a minimum reduced amount of diesel fuel Fdmin with which it is desired to operate in a multi fuel mode.

This determination is achieved by the microprocessor 56 looking up data stored in memory 57 which correlates different Fdmin to different Fe values (this correlation having been predetermined by experiment on the basis of the minimum amount of diesel fuel required to maintain safe operation of the engine using different amount mixtures of diesel/second fuel under predefined conditions).

Optionally at Step 3 the microprocessor 56 may also determine whether operation in a dual-fuel mode can occur. In this regard the minimum fuel energy value required Fe for dual-fuel operation to be possible is pre-determined by experimentation and stored within the memory 57. The microprocessor 56 compares the calculated fuel energy value Fe with the minimum value and allows dual-fuelling to start if the calculated fuel energy value Fe is greater than or equal to the minimum value.

The microprocessor 56 may also, at Step 3 enforce a preset minimum substitution limit, i.e. an upper limit to the amount of reduced diesel fuel Fdmin. Such a limit is desirable because the benefits of, for example, substituting only 1% of diesel fuel with a secondary fuel would be minimal. In addition, the secondary fuel injectors 31 may not be able to accommodate a very short injection of secondary fuel.

At the next step, Step 4 the microprocessor 56 calculates the air to fuel ratio AFRd needed to operate the engine in accordance with the operating instruction from ECU 60 (i.e. to meet the engine operating requirements at the time of activation by ECU 60) based upon the use of the mass of diesel Md (Step 2).

In order to perform this calculation, the microprocessor 56 receives input signals from the sensors represented by box 52, i.e. the microprocessor 56 receives input signals indicating the engine speed, and the air pressure and air temperature in the intake manifold 24.

At the next step, Step 5, the microprocessor 56 determines the air to fuel ratio AFRdual required, when using the diesel/second fuel mixture, in order to provide the same performance, i.e. power output when using diesel only (mass Md) at AFRd.

The determination in Step 5 is achieved knowing the maximum amount of second fuel possible (from Step 3) and amount of diesel required (Fdmin from Step 3). This determination can be made by calculation or by the microprocessor 56 looking up data stored in memory 57.

At the next step, Step 6, the microprocessor 56 calculates the amount of second fuel Msub required to provide (in combination with the fuel energy Fdmin provided by the minimum amount of diesel) the AFRdual determined in Step 5.

At the next step, Step 7, the microprocessor 56 conducts a comparative check to see whether the energy provided by the mass Md of diesel (Step 2) gives the same energy as calculated for the amounts of diesel/secondary fuel mixture (as determined by Steps 3 and 6). This step is optional, but provides a means of confirming that the preceding calculations are correct and, in the event of an error, allows the system readily to revert to 100% diesel so as to ensure safe operation of the engine.

At the next step, Step 8, the microprocessor 56 calculates the time duration of operation To for the second fuel injector 31 (i.e. the length of time the injector 31 needs to be open to deliver the amount of second fuel Msub determined to provide the required AFRdual).

Since the second fuel, in the present example is natural gas which is injected in gas form through injector 31, the microprocessor 56 calculates the duration based upon gaseous conditions.

Accordingly, in Step 8, the microprocessor 56 receives signals from sensors represented by box 53; these sensors include sensors which deliver signals indicative of gas pressure and temperature of the second fuel gas being supplied to the injector 31, and a sensor which provides signals indicative of absolute pressure in the intake manifold 24. In addition, stored in memory is data of known characteristics needed to make the calculation (of duration of injection); e.g. the mass flow rate of the injector 31 and gas injection system efficiency

In this context gas injection system efficiency is a performance parameter that relates to the quantity of gas that is actually drawn into the cylinder relative to the quantity of gas that is injected. Consideration of such a factor allows for changes in the injection system design and accommodates different system performances.

At the next step, Step 9, the microprocessor 56 determines the duration of time Ti available for injecting the calculated amount Msub of the second fuel and also the timing of the duration of time Ti with respect to operation of the engine.

In determining time Ti and its timing, the microprocessor 56 receives signals from sensors represented by box 54 which monitor performance of the engine; for example these sensors, such as sensors monitoring RPM of the engine and crank angle, provide signals indicative of the time of opening/closing of the inlet valve 22.

At the next step, Step 10, the microprocessor 56 provides to the ECU 50 an output signal Os at a desired point in time with respect to the engine cycle such that the ECU 50 operates to actuate the injector 31 to inject second fuel for the determined time Ti at the correct time in induction stroke of the engine cycle.

At the next step, Step 11, the microprocessor 56 provides to the ECU 50 an output signal Od to cause the ECU 50 to operate the injector 18 to deliver the calculated minimum reduced amount of diesel Fdmin to initiate the power stroke immediately following the induction stroke during which the second fuel/air mixture has been introduced.

At the next step, Step 12, the microprocessor 56 receives signals from sensors represented by box 55. These sensors provide feedback to the microprocessor 56 to enable the results of calculations to be modified to take into account actual combustion performance of the engine. Preferably such a sensor is a lambda sensor 29 which monitors the amount of unused oxygen in the exhaust gases and sends signals back to the microprocessor 56 to enable it to modify the calculated AFRdual value to improve efficiency of combustion.

The feedback from the lambda sensor 29 may be used to adjust either the quantity of diesel or natural gas, or the quantity of both fuels using a corresponding calibration factor. The calibration factor may not be used for every single injection cycle, but may be averaged over several cycles.

In the above example, the second fuel is natural gas which is injected through injector 31 in the form of a gas. It is to be appreciated that the second fuel could be a fuel which is injected in liquid form (e.g. petroleum) and that the microprocessor 56 would be programmed according to modify the calculations in Step 8.

1. A method for controlling the supply of a first fuel and a second fuel to an engine, which engine is fuelled by the first fuel only in a first mode of operation and by a mixture of the first fuel and the second fuel in a second mode of operation, the method comprising the steps of:
1) calculating the mass of first fuel Md required by the engine if running in the first mode;
2) calculating from the mass Md, the fuel energy Fe that the amount of mass Md would provide;
3) determining a minimum reduced amount of first fuel Fdmin required to operate in the second mode;
4) calculating the amount of second fuel Msub, which together with the minimum reduced amount of first fuel Fdmin will provide a fuel energy equivalent to Fe.

2. A method according to claim 1 wherein the step of determining Fdmin comprises the step of looking up data stored in a memory which correlates different Fdmin to different Fe values, which correlation has been predetermined by experiment on the basis of the minimum amount of first fuel required to maintain safe operation of the engine using different amount of mixtures of first and second fuel under predefined conditions.

3. A method according to claim 1 comprising the further step at step 3) of determining whether operation in the second mode is feasible.

4. A method according to claim 1 comprising the initial step of obtaining by experimentation, the minimum fuel energy value Fe required for operation in the second mode to be possible by experimentation, and storing the predetermined energy value within a memory.

5. A method according to claim 1 comprising the further step at step 3) of enforcing a preset minimum substitution limit, or an upper limit to the amount of reduced first fuel Fdmin.

6. A method according to claim 1 wherein the step of calculating the amount of second fuel Msub comprises the further steps of calculating the air to fuel ratio AFRd required to operate the engine in the first mode based on the use of the mass of first fuel Md;
determining the air to fuel ratio AFRdual required when operating the engine in the second mode in order to provide the same power output as when using the first fuel mass Md at AFRd;
calculating the amount of second fuel Msub required to provide, in combination with the fuel amount Fdmin the AFRdual.

7. A method according to claim 1 comprising the further step of conducting a comparative check to ascertain whether the energy Fe is substantially the same as the energy provided by the calculated required amounts of first and second fuel.

8. A method according to claim 1 wherein the steps are carried out for each power stroke of the engine.

9. A fuel injection system for an engine having a first electronic control unit arranged to control a plurality of main injectors for delivering a first fuel to the cylinders of the engine such that in a first mode of operation, the engine is fuelled by the first fuel only under the control of said first electronic control unit, the fuel injection system being arranged to operate to fuel the engine in a second mode of operation wherein a mixture of the first fuel and a second fuel is used to fuel the engine, the fuel injection system including a plurality of subsidiary injectors for delivering the second fuel into the engine, a second electronic control unit for controlling operation of the subsidiary injectors, the second electronic control unit being operatively connected to the first electronic control unit to receive output injector control signals therefrom and being connectable to the said main injectors for operating, in said second mode of operation, the main injectors to supply a reduced amount Fdmin of the first fuel and to control the subsidiary injectors to supply an amount of the second fuel Msub to provide a predetermined combined air to fuel ratio AFRdual for each power stroke of the engine.

10. A fuel injection system according to claim 9 wherein the second electronic control unit includes a microprocessor which is programmed to determine said amount Fdmin of the first fuel and said amount Msub of the second fuel based upon the duration of an output signal received from the first electronic control unit.

11. A fuel injection system according to claim 10 further including a plurality of sensors for sensing predetermined performance characteristics of the engine, the sensors being connected to the microprocessor to provide sensor signals thereto indicative of said performance characteristics and the microprocessor being responsive to said sensor signals when determining said Fdmin and Msub values.

12. A fuel injection system according to claim 11 wherein the microprocessor includes a memory in which data relating to predetermined performance characteristics is stored for access by the microprocessor when determining said Fdmin and Msub values.

13. A fuel injection system for an engine, the system including a first electronic control unit arranged to control a plurality of main injectors for delivering a first fuel to the cylinders of the engine such that in a first mode of operation, the engine is fuelled by the first fuel only under the control of said first electronic control unit, a second electronic control unit operable to fuel the engine in a second mode of operation wherein a mixture of the first fuel and a second fuel is used to fuel the engine, the system further including a plurality of subsidiary injectors for delivering the second fuel into the engine, the second electronic control unit being operably connected to the first electronic control unit to receive output injector control signals therefrom and in response to said output injector control signals, being arranged to control operation of the main and subsidiary injectors to supply a reduced amount Fdmin of the first fuel and to control the subsidiary injectors to supply an amount of the second fuel Msub to provide a predetermined combined air to fuel ratio AFRdual for each power stroke of the engine.

14.-15. (canceled)
